(19) United States
(12) Patent Application Publication
(10) Pub. No.: US 2024/0012409 A1
(43) Pub. Date: Jan. 11, 2024

(54) UNMANNED VEHICLE CONTROL, COMMUNICATION AND SAFETY SYSTEM AND METHOD

(71) Applicant: AUSTRALIAN DROID & ROBOT PTY LTD, Taringa, Queensland (AU)

(72) Inventors: Joe CRONIN, Taringa (AU); Andre PRELLER, Taringa (AU)

(21) Appl. No.: 18/036,308

(22) PCT Filed: Nov. 11, 2021
(86) PCT No.: PCT/AU2021/051341

§ 371 Date: May 10, 2023

(30) Foreign Application Priority Data
Nov. 11, 2020 (AU) 2020904136

(51) Int. Cl. G05D 1/00; G05D 1/02; B60L 3/04; B60L 3/00

(52) U.S. Cl. CPC G05D 1/0022; G05D 1/0027; G05D 1/0214; B60L 3/04; B60L 3/0092; B64U 2201/20

(57) ABSTRACT

An unmanned vehicle and methods and systems for unmanned vehicles are provided. The unmanned vehicle includes a data interface, adapted to receive navigation data; a drive controller, configured to drive the vehicle according to the navigation data; and a safety controller, independent of the drive controller, configured to analyse at least part of the navigation data and deactivate a drive function of the drive controller upon determining an error in the navigation data.

### TECHNICAL FIELD

The present invention relates to unmanned vehicles. In particular, although not exclusively, the present invention relates to control, communication and safety systems in unmanned wheeled vehicles, tracked vehicles and drones (unmanned aerial vehicles).

### BACKGROUND ART

The use of unmanned vehicles has become increasingly popular, particularly in hazardous areas such as mines, and in areas that are otherwise difficult or costly to access. In particular, unmanned vehicles can be used to access and monitor dangerous areas, or to collect data that would otherwise be time consuming to perform manually.

A problem with the use of unmanned vehicles is that they can be dangerous around persons and other equipment. In particular, unmanned vehicles may cause injury to persons directly, or may indirectly cause injury by creating a dangerous situation.

Certain systems exist which put safety parameters around operation of autonomous equipment, such as by limiting the forces or speed of the equipment. However, even if forces and speed are limited in unmanned vehicles, they can still create dangerous situations.

As an illustrative example, unmanned vehicles generally rely on external input, such as commands, for navigation. In case this data is missing or corrupt, dangerous situations may occur. In the simplest example, if an emergency stop message is not received, an unmanned vehicle may continue to operate, unaware of the danger it is causing. Furthermore, even if a dangerous situation does not occur, damage or loss to the unmanned vehicle can occur, which is clearly undesirable.

Such problems are exacerbated in underground environments where robust communications networks are not available or feasible, as signals are more likely to be lost or corrupted.

As such, there is clearly a need for improved and more reliable vehicle control, communications and safety systems and methods.

It will be clearly understood that, if a prior art publication is referred to herein, this reference does not constitute an admission that the publication forms part of the common general knowledge in the art in Australia or in any other country.

### SUMMARY OF INVENTION

The present invention is directed to unmanned vehicle control, communication and safety systems and methods, which may at least partially overcome at least one of the abovementioned disadvantages or provide the consumer with a useful or commercial choice.

With the foregoing in view, in a first aspect the present invention resides broadly in an unmanned vehicle comprising:
a data interface, adapted to receive navigation data;
a drive controller, configured to drive the vehicle according to the navigation data; and
a safety controller, independent of the drive controller, configured to analyse at least part of the navigation data and deactivate a drive function of the drive controller upon determining an error in the navigation data.

Advantageously, the system enables safe operation of the unmanned vehicle when there are errors in the navigation data. As the safety controller is independent of the drive controller, the safety controller is not reliant on any output from the drive controller to function properly. This in turn enables the safety controller to halt driving of the vehicle even when the drive controller is malfunctioning and sending drive instructions to motors or actuators of the vehicle, for example.

Preferably, deactivating a drive function of the drive controller comprises breaking a power circuit associated with the drive controller. The power circuit may be configured to power one or more motors or actuators of the vehicle to thereby drive the vehicle. As such, breaking the power circuit will prevent the motors or actuators from further driving the vehicle.

The vehicle may comprise a land vehicle, such as a wheeled or tracked vehicle. The wheeled or tracked vehicle may comprise a robot.

The vehicle may alternatively comprise an unmanned aerial vehicle, such as a drone or unmanned helicopter. As such, the term “drive” is used broadly herein to refer to causing the vehicle to move in a specified direction.

The vehicle may comprise an autonomous or semi-autonomous vehicle. In such case, the navigation data may include destination data, wherein the vehicle autonomously travels to destinations defined by the destination data.

The vehicle may be remotely controlled by the navigation data. The navigation data may include a sequence of commands.

The navigation data may be provided in packets. Each packet may be individually decodable.

The packets may be sent in a packet stream. The sequence of packets may define a sequence of commands.

The error in the packet data may include a missing packet in the packet stream.

The safety controller may determine an error in the navigation data according to one or more checksums of the navigation data.

The safety controller may determine an error in the navigation data by determining that the navigation data does not comply with one or more predefined rules.

The safety controller may determine an error in the navigation data by determining that packets have not been received at a predefined frequency.

The safety controller may determine an error in the navigation data by determining that packets are missing.

The power circuit of the vehicle may comprise a drive power circuit of the vehicle. The vehicle may include a functional circuit, independent of the drive power circuit, to enable one or more non-drive functions of the vehicle to be provided when the drive power circuit is broken.

The vehicle may include one or more cameras, sensors and/or peripherals which are configured to function when the drive circuit is broken.

The vehicle may include one or more relays, wherein the drive power circuit may be broken by each of the one or more relays.

The vehicle may include a safety relay, which is configured to break the drive power circuit according to input from the safety controller. The vehicle may include a functional relay, which is configured to break the drive power circuit according to input that is not from the safety controller.

The safety relay and the functional relay may be coupled in sequence.

The safety relay and the functional relay may be coupled intermediate a battery of the vehicle and one or more motors or actuators of the vehicle. The one or more motors or actuators may be configured to drive the vehicle.

The use of the safety and functional relays provides redundancy in case a functional controller of the vehicle malfunctions, for example.

Preferably, the vehicle includes a functional circuit, configured to control cameras, peripherals, and/or sensors, wherein the functional circuit does not include the relays. Such configuration may keep non-drive aspects of the vehicle functional while the power drive circuit is broken.

The vehicle may include a safety module, comprising the safety controller and one or more relays. The safety module may be connected to the vehicle in a modular manner. The safety module may be connected to a power circuit of the vehicle in a manner that is transparent to any drive controller or processor that controls any motors or actuators.

The data interface may be adapted to communicate with other vehicles. The data interface may be adapted to forward received signals to another vehicle or a base station.

The data interface may be configured to provide a mesh network between a plurality of vehicles.

In a second aspect the present invention, the invention resides broadly in a safety system for an unmanned vehicle including:
a data interface, adapted to receive navigation data;
a processor, configured to analyse at least part of the navigation data; and
a relay adapted to be coupled into a power circuit of the vehicle, the relay selectably able to deactivate a drive function of the vehicle according to input from the processor,
   wherein the processor is configured to deactivate a drive function of the vehicle upon determining an error in the navigation data, and wherein the processor is independent of a drive controller, which is otherwise configured to drive the vehicle according to the navigation data.

In a third aspect the present invention, the invention resides broadly in an unmanned vehicle system comprising:
a plurality of unmanned vehicles, each unmanned vehicle comprising:
   a data interface, adapted to form a mesh network with other unmanned vehicles;
   a drive controller, configured to drive the vehicle according to the navigation data received on the data interface; and
   a safety controller, independent of the drive controller, configured to analyse at least part of the navigation data and deactivate a drive function of the vehicle upon determining an error in the navigation data; and
a base station, coupled to at least one of the plurality of unmanned vehicles, wherein the base station is configurable to communicate with each of the vehicles through the mesh network.

In a fourth aspect the present invention, the invention resides broadly in an unmanned vehicle method for use on an unmanned vehicle, the method comprising:
receiving, on a data interface, navigation data;
driving, by a drive controller of the unmanned vehicle, the unmanned vehicle according to the navigation data;
analysing, by a safety controller independent of the drive controller, at least part of the navigation data; and
deactivating a drive function of the vehicle of the vehicle upon determining an error in the navigation data.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a simplified schematic of an unmanned vehicle, according to an embodiment of the present invention.

FIG. 2 illustrates a schematic of a controller for an unmanned vehicle, according to an embodiment of the present invention.

FIG. 3 illustrates a simplified schematic of an unmanned vehicle, according to an embodiment of the present invention.

FIG. 4 illustrates a schematic of an unmanned vehicle communication system, according to an embodiment of the present invention.

FIG. 5 illustrates an unmanned vehicle method, for use in an unmanned vehicle, according to an embodiment of the present invention.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

Embodiments of the present invention are disclosed which enable safe operation of the vehicle, even when there are errors in the navigation data received by the vehicle. Safety of the system is not reliant on any drive controller to function properly, and thus works even when the drive controller is malfunctioning, as malfunctioning drive instructions sent to motors or actuators may be simply overridden.

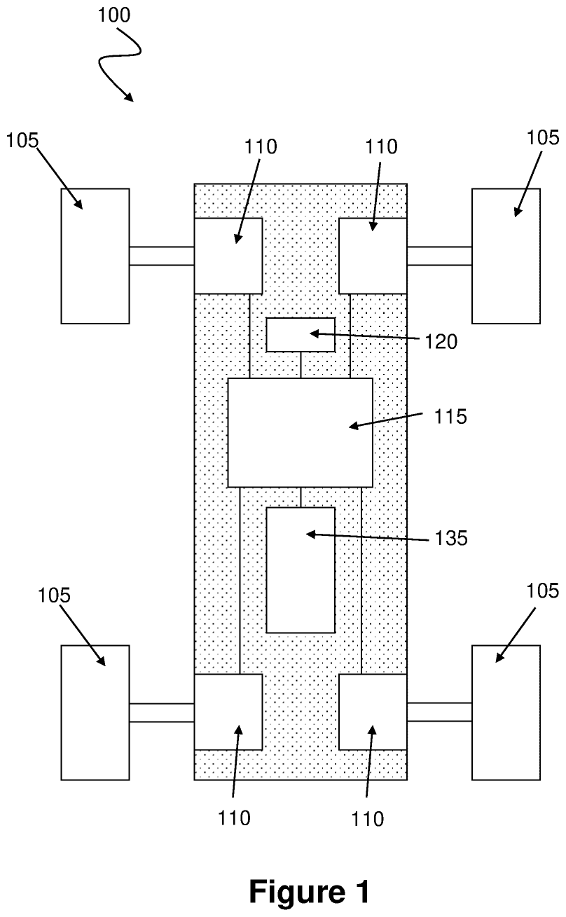

FIG. 1 illustrates a simplified schematic of an unmanned vehicle 100, according to an embodiment of the present invention. The unmanned vehicle 100 includes a plurality of wheels 105, driven by individual motors 110, to enable the vehicle to navigate and steer, particularly across rough surfaces, such as those present in underground mining environments.

While the unmanned vehicle 100 illustrated in FIG. 1 comprises a wheeled robot, the skilled addressee will readily appreciate that many of the teachings herein relating to the unmanned vehicle 100 may be applied to a variety of different types of unmanned vehicles, including track driven vehicles and aerial vehicles (e.g. drones).

The unmanned vehicle 100 includes a vehicle controller 115, which controls the motors 110. In particular, the vehicle controller 115 outputs a pulse width modulated (PWM) signal to each of the motors to allow precise movement of the vehicle. As will be readily understood by the skilled addressee, different signals may be applied to the different motors 110 and thereby different wheels 105 to provide steering.

A wireless data interface 120 is coupled to the controller 115, on which navigation instructions are received. The navigation instructions may include messages indicating a direction in which the vehicle should travel, a distance the vehicle should travel, parameters within which a vehicle should travel, a desired location, or any suitable navigation parameters. The navigation instructions are provided in individual packets (or messages), which are each individually decodable and executable, and a stream of packets is provided to give continual navigation data.

Finally, a battery 125 is coupled to the controller 115 and is configured to power the motors 110 (and the controller 115). The controller 115 has two main functions: 1) to decode the navigation instructions and control the motors based thereon; and 2) to provide safety by preventing the motors 110 from running in case of errors or when parameters are outside of certain thresholds. As outlined below, these two functions may be provided by separate controllers or processors.

The controller 115 separates power to the motors 110 from control signals to the motors 110. This enables the controller 115 to stop power to the motors 110 independently of the control signals. This is achieved using relays, as outlined in further detail below, and ensures that even if there are problems with the control signals, the motors 110 do not inadvertently operate, thereby alleviating safety issues associated therewith.

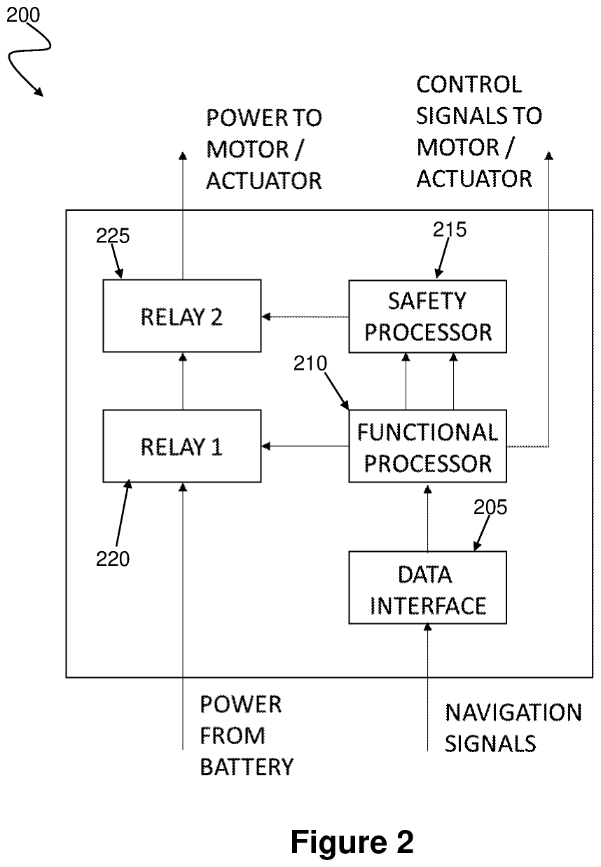

FIG. 2 illustrates a schematic of a controller 200, according to an embodiment of the present invention. The controller 200 is for an unmanned vehicle, and is used to process navigation instructions and provide safety by preventing the motors from operating inadvertently. The controller may be similar or identical to the controller 115.

The controller 200 includes a data interface 205, on which navigation signals are received. As outlined earlier, the navigation instructions are provided in a stream of packets which are individually decodable and actionable. This simplifies processing of the navigation signals as it enables predefined or partially predefined actions to be performed based thereon.

The packets are forwarded from the data interface 205 to a functional processor 210, which decodes the packets and generates control signals to the motors and/or actuators of the associated with the unmanned vehicle. The functional processor 210 also forwards the packets to a safety processor 215. In alternative embodiments, the packets are sent from the data interface 205 to the safety processor 215 directly.

The safety processor 215 is configured to check the packets for errors or inconsistencies, and in case of any errors or inconsistencies, power to the motors and/or actuators is cut. Examples of checks include identifying a heartbeat signal, determining that packets have been received at or above a predetermined frequency, verifying packet checksums, verifying packet sequence, determining missing packets (e.g. based upon sequence numbers), or any other suitable error checking.

Power from a battery to the motors and/or actuators passes through first and second relays 220, 225 of the controller 200, each of which enables an open circuit to be created with the motors and/or actuators, thereby preventing the motors from operating regardless of whether any navigation or control signals are provided to the motor by the functional processor 210.

The functional processor 210 is coupled to the first relay 220, and is configured to open the first relay 220 (i.e. create an open circuit to the motors and/or actuators) based upon the navigation signals. As an illustrative example, the navigation signals may include an emergency stop (E-stop) signal, which causes the functional processor 210 to open the first relay 220.

The safety processor 210 is coupled to the second relay 225, and is configured to open the second relay 225 (i.e. create an open circuit to the motors and/or actuators) when an error or fault condition is identified in the navigation packets (e.g. a packet is missing or a heartbeat signal has not been received within a threshold time period).

As the first and second relays 220, 225 are coupled in series, either of the relays is able to open the circuit to the motors and/or actuators. This provides redundancy to the system as even if the functional processor 210 fails to shut off the motors and/or actuators, the safety processor 215 is able to alone and independently open the circuit to the motors and/or actuators.

As outlined in further detail below, the functional controller is able to receive signals from and interface with a variety of other sensors and peripherals.

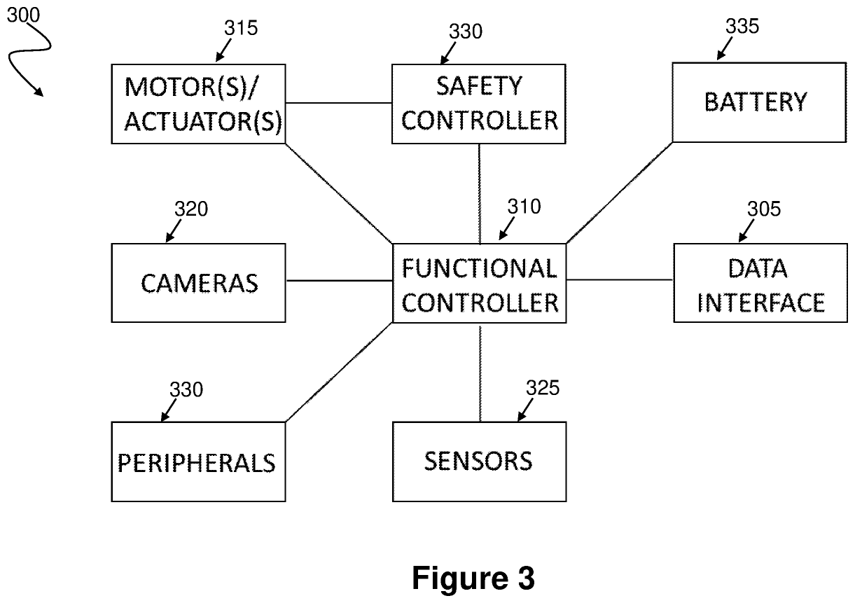

FIG. 3 illustrates a simplified schematic of an unmanned vehicle 300, according to an embodiment of the present invention. The unmanned vehicle 300 may be similar to the vehicle 100.

The vehicle 300 includes a data interface 305 on which navigation signals are received, and a functional controller 310 to decode and act on the navigation signals. The functional 310 controller includes a processor and memory, and is configured to receive the navigation signals, which may comprise a stream of packets, and decode same, and determine control signals to one or more motor(s) or actuator(s) 315.

The control signal to the one or more motor(s) or actuator(s) 315 may comprise a pulse width modulated signal, and in the case of a wheeled vehicle, different signals may be provided to different wheels to provide steering, for example.

The vehicle 300 includes one or more cameras 320, for capturing images from the environment of the vehicle, sensors 325, for capturing data about the environment, and peripherals 330, such as lights or equipment, for interacting with the environment. The cameras 320 and sensors 325 are coupled to the functional controller 310, and are used as input to decision making functions in the controller.

As an illustrative example, the cameras 320 and sensors 325 may be used to monitor a movement of the vehicle 300, and thereby provide a feedback loop to the functional controller 320 regarding a location of the vehicle 300. Similarly, the sensors 325 may include temperature, voltage or current sensors, configured to identify erroneous conditions in the motors or actuators 315. As an illustrative example, in case the vehicle 300 becomes stuck and the motors or actuators 315 start to overheat, the functional controller 310 may detect such situation and shut off the motors or actuators 315.

The vehicle 300 further includes a safety controller 330, coupled to the functional controller 310 and the motors or actuators 315. The safety controller 330 is configured to detect faults or problems in the navigational data or the vehicle itself, and shut down the motors or actuators 315 in response thereto.

A battery 335, which powers the vehicle 300, is coupled to the functional controller 310 and thereby to the other components of the vehicle. A power circuit is provided between the battery 335 and the motors or actuators 315 to power the motors or actuators 315, and a control circuit is provided between the functional controller 310 and the motors or actuators 315 to control the motors or actuators 315.

The power circuit extends from the battery 335, through the functional controller 310 and the safety controller 330 to the motors or actuators 315. The functional controller 310 and the safety controller 330 include relays which enable the power circuit to be broken, thereby preventing power to the circuit and therefore the motors or actuators 315.

The functional controller 310 may break the circuit powering the motors or actuators 315 upon receiving an emergency stop signal, or sensing that one or more parameters of the vehicle, such as the voltage, current or temperature at a motor 315, is outside of predefined parameters.

The safety controller 330 operates independently of the functional controller 310, and may comprise an independent module in the vehicle 300. The safety controller 330 is configured to detect errors, inconsistencies or missing data in the navigational data and break the circuit powering the motors or actuators 315. As the safety controller 330 operates independently of the functional controller 310, it is able to deactivate the motors or actuators 315 even when the functional controller 310 malfunctions.

In some embodiments, the safety controller is a standalone module that may be retrofitted to existing vehicles, or installed into vehicles in a module fashion. In may include connectors, for connecting the power circuit therethrough, such that the power circuit travels through one or more relays therein. The functional controller 310 may operate without regard to the safety controller 330, as the safety controller effectively provides coarse control of the motors or actuators 315, i.e. either on or off.

As outlined earlier, the vehicles described herein may be particularly suited for use in underground environments, such as underground mines. In such case, however, communications networks are not readily available, have relatively short operating distances, and may be unreliable, particularly if large amounts of data are to be transmitted, such as video.

In such situations, multiple vehicles may work together to relay the data back out of the environment, essentially creating a mesh network, enabling greater data throughput and increased reliability.

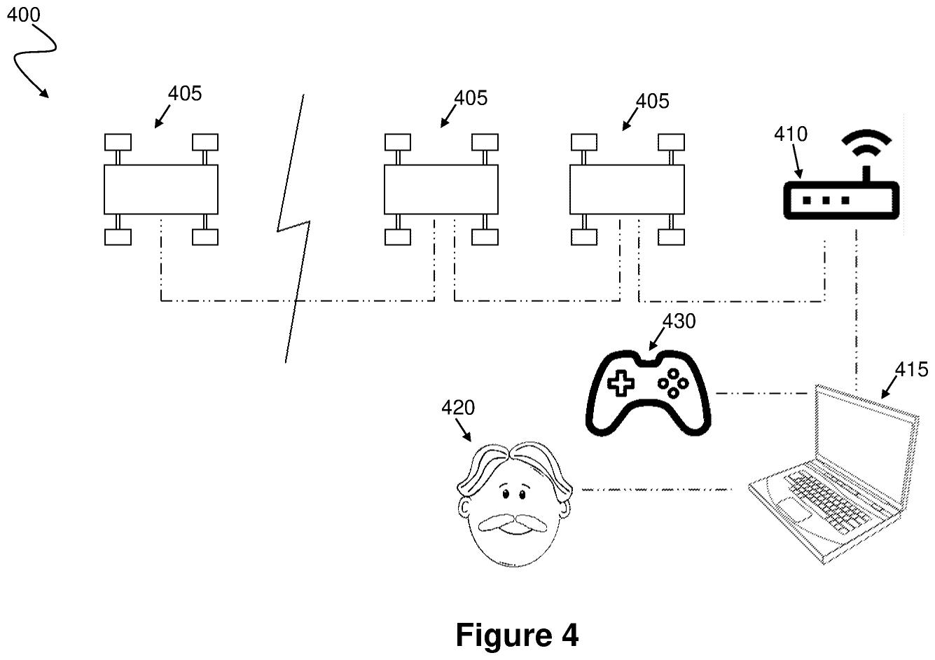

FIG. 4 illustrates a schematic of an unmanned vehicle communication system 400, according to an embodiment of the present invention.

The system 400 includes a plurality of unmanned vehicles 405, which may be similar to the vehicles described above, which are in communication with a base station 410 and each other to thereby create a mesh network.

A computing device 415, such as a laptop, is coupled to the base station 410, to enable an operator 420 to view data from the unmanned vehicles 405, such as video, and a user input device 430 is coupled to the computing device 415 to enable the operator 420 to input navigational data.

In one example, a first unmanned vehicle 405 may be driven into an area to be monitored (e.g. a part of an underground mine), based upon commands input by the operator 420 using the input device 430. At the same time, video from the first unmanned vehicle 405 may be streamed back to the laptop 415, and displayed therein, thereby assisting the operator 420 with the navigation.

Second and subsequent unmanned vehicles 405 may be configured to follow a path of the first vehicle 405 in a predefined arrangement (e.g. spaced by a certain distance). When the first vehicle 405 is out of range of the base station 410, it may communicate with the base station 410 through the second and subsequent vehicles 405. As a result, the vehicles 405 may enable areas to be accessed that are not suitable for direct wired or wireless communication.

Each of the vehicles 405 may be configured to receive a heartbeat signal, e.g. at least one signal within a predefined period. Similarly, each of the vehicles may be configured to determine the integrity of any received signals.

In case an error is detected, e.g. a missing or corrupt packet, the drive power of the vehicle 405 may be interrupted (e.g. by opening a relay in the drive power circuit). This will cause the vehicle 405 to stop, while maintaining power to its other functions, such as communications. A message may then be provided to the base station 410. Alternatively, the vehicles 405 may be configured to send a heartbeat signal back to the base station 410.

In case a vehicle error is occurs, the operator 420 is notified using the computing device 415. The operator 420 is then able to work towards rectifying the error.

As an illustrative example, in the case of a communication breakdown in the mesh network, where a vehicle 405 is not receiving the appropriate instructions, the operator 420 may reconfigure vehicles to travel closer to each other, and may deploy further vehicles to re-establish the network.

As the vehicles 405 are prevented from driving in case of an error, the vehicles are prevented from operating according to old instructions, which may cause a dangerous situation, or result in a vehicle from becoming lost. Even in the case of a corrupt message, which may be incorrectly interpreted, the safety controller is able to physically disconnect the motors.

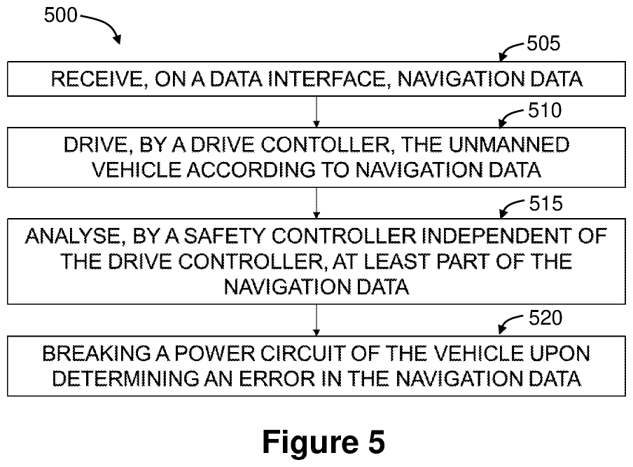

FIG. 5 illustrates an unmanned vehicle method 500, for use in an unmanned vehicle, such as an unmanned vehicle as outlined above, according to an embodiment of the present invention. The unmanned vehicle method 500 ensures that the unmanned vehicle is able to go into a safe mode of operation when there are errors in the navigation data, even if a motor controller malfunctions.

At step 505, navigation data is received on a data interface. The navigation data may comprise commands or instructions, executable by the vehicle, such as a forward command, a reverse command, a steer command, or a combination thereof.

At step 510, a drive controller of the unmanned vehicle drives the unmanned vehicle according to the navigation data. The drive controller may, for example, provide pulse width modulated signals to motor controllers of the vehicle.

At step 515, a safety controller, which is independent of the drive controller, analyses at least part of the navigation data for error. This can include analysing packets of navigational data for missing packets, verifying checksums, or even determining that packets have not be received according to a predefined schedule (e.g. a heartbeat signal is missing).

At step 520, a power circuit of the vehicle is broken (opened) upon determining an error in the navigation data. This may be achieved by opening a relay of a circuit associated with powering one or more motors.

If there is no error in the navigation data, instead of step 520, the process is repeated at step 505. This is done continuously to ensure that the power circuit of the vehicle is able to be broken as an error in the navigational data is detected.

While the above examples describe disconnecting a power circuit in a motor, which is particularly useful for land vehicles, other means of deactivating a drive function of the vehicle may be provided.

As an illustrative example, in aerial vehicles, such as unmanned helicopters, the drive function of the aerial vehicle may be disconnected and replaced by a safety controller which is configured to cause the aerial vehicle to hover, or otherwise operate in a safe manner.

Similarly, while the above embodiments describe a single power circuit, the skilled addressee will readily appreciate that multiple power circuits may be used and interrupted using relays. As an illustrative example, different drive circuits may be provided to each of a plurality of wheels, and each circuit may be broken by relays, either together (stopping the entire vehicle), or individually (stopping power to one or more wheels).

While the above examples focus on commands received by an operator, the skilled addressee will readily appreciate that the vehicles may operate in an autonomous or semi-autonomous manner. As an illustrative example, an operator may provide high level instructions to an autonomous vehicle (e.g. destination data), from which it autonomously operates. In such case, the safety controller may check both the high level instructions, as well as internal instructions generated by an autonomous controller of the vehicle.

While any suitable vehicle may be used, in some embodiments, a wheeled robot is particularly suited. The robot may include four or more wheels (e.g. six or eight wheels), arranged in parallel rows, enabling the robot to navigate in a wide range of environments. In such case, a body mounted to the wheels of the robot may be mounted such that high clearance is provided to enable navigation over rocks and uneven surfaces.

The vehicle may be any suitable size, but is generally compact to enable it to efficiently traverse a wide range of excavations. In one embodiment, the vehicle is less than about 2 m in length, width, and height. In one embodiment, the vehicle is less than about 1 m in length, width, and height.

In addition to navigating and collecting data, the vehicles may perform a variety of functions. As an illustrative example, the vehicles may include actuators in the form of a robotic arm, which may articulate, and perform a variety of functions. As an illustrative example, the arm may include drills, cutters, or digging implements, to enable the vehicle to perform auxiliary functions that may be beneficial in a mine site.

While the above examples are described with reference to electric motors and batteries, the skilled addressee will readily appreciate that the motors and battery are simply one example of a propulsion system, and other systems may be used, including combustion or gas-powered engines, or a combination thereof. In such case, power to a combustion engine may be cut off by shutting off a fuel supply.

While the above examples describe stopping the driving of the unmanned vehicle by shutting off the drive motors, the methods and systems may alternatively or additionally apply emergency brakes preventing the motors from running.

Advantageously, the embodiments of the present invention described above enable safe operation of the vehicle, even when there are errors in the navigation data received by the vehicle. The safety of the systems and methods is not reliant on any drive controller to function properly, and thus works even when the drive controller is malfunctioning, as malfunctioning drive instructions sent to motors or actuators may be simply overridden.

The system is modular, and may be installed into unmanned vehicles in a relatively simple manner. No modification to normal drive function of the vehicle need be made, and the drive modules of the vehicle need not be even aware that the safety systems have even been installed. As a result, the systems are inexpensive.

The systems and methods also provide an efficient way of inspecting dangerous areas, such as underground mines, where traditional communications networks are not suitable. The communications aspects of the system are also easily scalable, as the mesh networks disclosed herein may be increased in size by adding more vehicles.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An unmanned vehicle comprising:
a data interface, adapted to receive navigation data;
a drive controller, configured to drive the vehicle according to the navigation data; and
a safety controller, independent of the drive controller, configured to analyse at least part of the navigation data and deactivate a drive function of the drive controller upon determining an error in the navigation data.

2. The unmanned vehicle of claim 1, wherein deactivating the drive function of the drive controller comprises breaking a power circuit associated with the drive controller, wherein the power circuit is configured to power one or more motors or actuators of the vehicle to thereby drive the vehicle such that breaking the power circuit will prevent the motors or actuators from further driving the vehicle.

3. (canceled)

4. The unmanned vehicle of claim 1, wherein the vehicle comprises an unmanned land vehicle, wherein the unmanned land vehicle comprises a wheeled or tracked robot.

5. (canceled)

6. The unmanned vehicle of claim 1, wherein the vehicle comprises an unmanned aerial vehicle.

7. The unmanned vehicle of claim 1, wherein the vehicle comprises an autonomous or semi-autonomous vehicle, wherein the navigation data includes destination data, wherein the vehicle autonomously or semi-autonomously travels to destinations defined by the destination data.

8. (canceled)

9. The unmanned vehicle of claim 1, wherein the vehicle is remotely controlled by the navigation data, the navigation data including a sequence of commands.

10. The unmanned vehicle of claim 9, wherein the navigation data is provided in packets, wherein each packet is individually decodable.

11. The unmanned vehicle of claim 10, wherein the packets are sent in a packet stream, wherein a sequence of the packets defines a sequence of commands, wherein determining the error in the navigation data comprises determining a missing packet in the packet stream.

12. (canceled)

13. (canceled)

14. The unmanned vehicle of claim 10, wherein the safety controller is configured to determine an error in the navigation data according to one or more checksums of the navigation data; by determining that packets of navigation data have not been received at a defined frequency; or by determining that packets are missing.

15. The unmanned vehicle of claim 1, wherein the safety controller is configured to determine an error in the navigation data by determining that the navigation data does not comply with one or more predefined rules.

16. (canceled)

17. (canceled)

18. The unmanned vehicle of claim 2, wherein the power circuit of the vehicle comprises a drive power circuit of the vehicle, wherein the vehicle includes a functional circuit, independent of the drive power circuit, to enable one or more non-drive functions of the vehicle to be provided when the drive power circuit is broken.

19. The unmanned vehicle of claim 18, further including one or more cameras, sensors and/or peripherals which are configured to function when the drive circuit is broken.

20. The unmanned vehicle of claim 18, further including one or more relays, wherein the drive power circuit may be broken by each of the one or more relays.

21. The unmanned vehicle of claim 1, wherein the vehicle includes a safety relay, which is configured to break the drive power circuit according to input from the safety controller, and a functional relay, which is configured to break the drive power circuit according to input that is not from the safety controller.

22. (canceled)

23. The unmanned vehicle of claim 21, wherein the safety relay and the functional relay are coupled in sequence, wherein the safety relay and the functional relay are coupled intermediate a battery of the vehicle and one or more motors or actuators of the vehicle, the one or more motors or actuators may be configured to drive the vehicle.

24. (canceled)

25. The unmanned vehicle of claim 23, wherein the vehicle includes a functional circuit, configured to control cameras, peripherals, and/or sensors, wherein the functional circuit does not include the relays.

26. The unmanned vehicle of claim 1, wherein the vehicle includes a safety module, comprising the safety controller and one or more relays, wherein the safety module is connected to a power circuit of the vehicle in a manner that is transparent to the drive controller when the drive function of the drive controller is functioning.

27. (canceled)

28. The unmanned vehicle of claim 1, wherein the data interface is further adapted to communicate with other vehicles, wherein the data interface is adapted to forward received signals to another vehicle or a base station to provide a mesh network between a plurality of vehicles.

29. (canceled)

30. A safety system for an unmanned vehicle including:
a data interface, adapted to receive navigation data;
a processor, configured to analyse at least part of the navigation data; and
a relay adapted to be coupled into a power circuit of the vehicle, the relay selectably able to deactivate a drive function of the vehicle according to input from the processor, wherein the processor is configured to deactivate a drive function of the vehicle upon determining an error in the navigation data, and wherein the processor is independent of a drive controller, which is otherwise configured to drive the vehicle according to the navigation data.

31. An unmanned vehicle system comprising:
a plurality of unmanned vehicles, each unmanned vehicle comprising:
a data interface, adapted to form a mesh network with other unmanned vehicles;
a drive controller, configured to drive the vehicle according to the navigation data received on the data interface; and
a safety controller, independent of the drive controller, configured to analyse at least part of the navigation data and deactivate a drive function of the vehicle upon determining an error in the navigation data; and
a base station, coupled to at least one of the plurality of unmanned vehicles,
wherein the base station is configurable to communicate with each of the vehicles through the mesh network.

32. (canceled)
